(19) United States
(12) Patent Application Publication
(10) Pub. No.: US 2012/0090489 A1
(43) Pub. Date: Apr. 19, 2012

(54) NANOIMPRINT METHOD

(76) Inventors: Masato SUZUKI, Yokoham-shi (JP); Shinji Mikami, Kawasaki-Shi (JP); Kentaro Kasa, Kawasaki-Shi (JP)

(21) Appl. No.: 13/229,234

(22) Filed: Sep. 9, 2011

(30) Foreign Application Priority Data
Oct. 19, 2010 (JP) 2010-234195

(51) Int. Cl. B41F 1/34

(52) U.S. Cl. 101/485

(57) ABSTRACT

According to one embodiment, a nanoimprint method includes: performing imprinting by use of a first template, to form a pattern on a first substrate to be transferred; measuring an alignment deviation of the pattern with respect to the first substrate to be transferred; performing alignment-deviation correction based on the measured alignment deviation, to produce a third template by use of the first template; and performing imprinting by use of the third template, to form a pattern on a second substrate to be transferred.

### CROSS-REFERENCE TO RELATED APPLICATION

This application is based upon and claims the benefit of priority from prior Japanese Patent Application No. 2010-234195, filed on Oct. 19, 2010, the entire contents of which are incorporated herein by reference.

### FIELD

Embodiments of the present invention relate to a nanoimprint method.

### BACKGROUND

In a manufacturing method for a semiconductor device, as a technique for realizing both formation of a fine pattern being 100 nm or less and mass-productivity thereof, attention has been focused on a nanoimprint method in which an original plate pattern (template) is transferred to a substrate to be transferred.

The nanoimprint method is a method of pressing a patterned template to a resist layer made of an imprint material applied on the substrate to be transferred and curing the resist layer.

As the nanoimprint method, there exist a thermal imprint method and an optical imprint method. For example, as the optical nanoimprint method, there is known a method including the following steps (1) to (6):

(1) a step of applying a photo-curable resist as an imprint material to a substrate to be transferred;

(2) a step of performing alignment between the substrate to be transferred and a template;

(3) a step of pressing the template to (bringing the template into contact with) a resist;

(4) a step of curing the resist by optical irradiation;

(5) a step of releasing the template (mold-releasing) and rinsing the substrate to be transferred and the resist; and

(6) a step of removing an unnecessary resist (residual film) on the substrate to be transferred by anisotropic etching or the like.

The template used in the light nanoimprint method is, for example, one obtained by forming a concave-convex pattern by plasma etching on a fully transparent quartz substrate for use in an ordinary photomask. When a pattern arrangement of a memory device is taken as an example, a memory cell pattern made up of lines and spaces is formed in a central part of each chip, and on the outside thereof, a pattern of a peripheral circuit is formed. On the further outside thereof, a dicing area which is a cutting portion of the chip, and in this dicing area, an alignment mark for alignment is formed.

In the nanoimprint method, an alignment deviation between the transferred pattern and the pattern formed on the substrate to be transferred is checked through use of the alignment mark. A general operation is that, when an alignment deviation amount is within a specification value, the process goes to a next processing step, but when the alignment deviation amount exceeds the specification value, the resist layer formed with the transferred pattern is peeled off and the process again goes through the transfer process. When exceeding the specification value, the alignment deviation amount measured in the alignment deviation checking step is fed back to the transfer step, and distortion correction for reducing the alignment deviation is performed.

### BRIEF DESCRIPTION OF THE DRAWINGS

FIG. 1 is a flow diagram showing steps of a nanoimprint method according to a first embodiment;

FIGS. 2A to 2D are views for explaining the steps of the nanoimprint method according to the first embodiment;

FIG. 3 is a view for explaining a step of measuring an alignment deviation between patterns;

FIGS. 4A to 4C are views for explaining the step of measuring the alignment deviation between the patterns;

FIG. 5 is a view for explaining the step of measuring the alignment deviation between the patterns;

FIG. 6 is a view for explaining the step of measuring the alignment deviation between the patterns;

FIG. 7 is a view for explaining the step of measuring the alignment deviation between the patterns;

FIG. 8 is a flow diagram showing steps of a nanoimprint method according to a second embodiment; and

FIGS. 9A to 9E are views for explaining the steps of the nanoimprint method according to the second embodiment.

### DETAILED DESCRIPTION

In one embodiment, a nanoimprint method includes: performing imprinting by use of a first template, to form a pattern on a first substrate to be transferred; measuring an alignment deviation of the pattern with respect to the first substrate to be transferred; performing alignment-deviation correction based on the measured alignment deviation, to produce a third template by used of the first template; and performing imprinting by use of the third template, to form a pattern on a second substrate to be transferred.

### First Embodiment

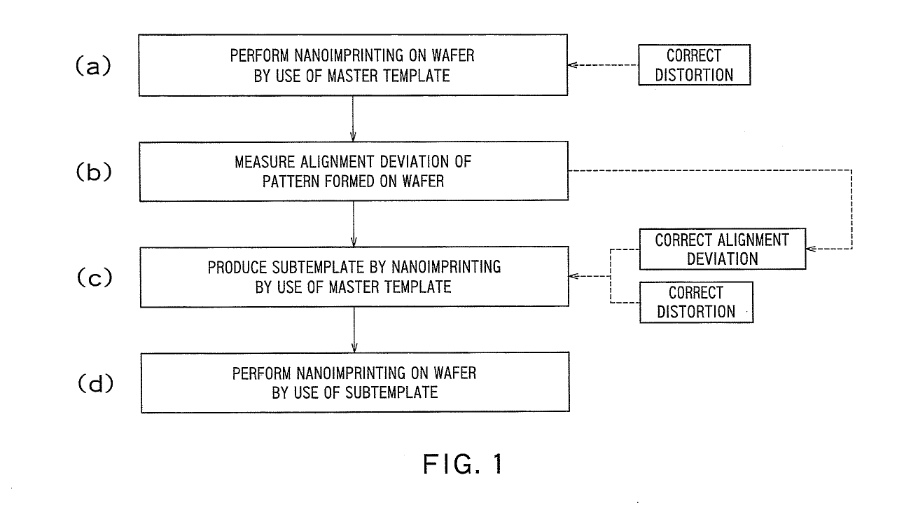

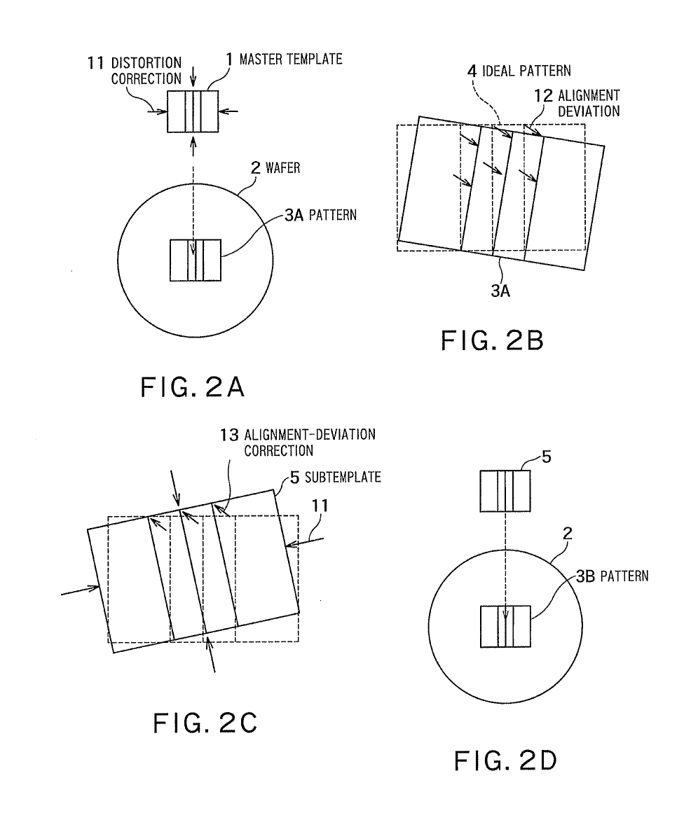

FIG. 1 is a flow diagram showing steps of a nanoimprint method according to a first embodiment. Further, FIGS. 2A to 2D are views for explaining the steps of the nanoimprint method according to the first embodiment.

The present embodiment is a nanoimprint method having the following steps:

(1) a step of performing imprinting by use of a template, to form a pattern on a first substrate to be transferred (wafer, for example) (FIGS. 1(a) and 2A);

(2) a step of measuring an alignment deviation of the pattern with respect to the first substrate to be transferred (FIGS. 1(b) and 2B);

(3) a step of performing alignment-deviation correction based on the measured alignment deviation, to produce a template for actual imprinting from the above template (FIGS. 1(c) and 2C); and

(4) a step of performing imprinting by use of the template for actual imprinting, to form a pattern on a second substrate to be transferred (wafer, for example) (FIGS. 1(d) and 2D).

Hereinafter, the steps (1) to (4) will be sequentially described.

### [(1) Step of Forming Pattern on Wafer]

A master template 1 is nanoimprinted on a wafer 2, to form a pattern 3A on the wafer 2. The master template 1 is, for example, one obtained by forming a concave-convex pattern on a fully transparent quartz substrate by plasma etching.

Herein, at the time of performing nanoimprinting, distortion correction 11 is preferably applied to the master template 1. The distortion correction 11 is performed by a known method described in Patent Document 2. Specifically, a positional relation between an alignment mark previously formed on the wafer 2 and an alignment mark previously formed on the master template 1 is measured, and based on a result of the measurement, correction (distortion correction 11) is performed on the master template 1.

### [(2) Step of Measuring Alignment Deviation of Pattern]

Next, as for the pattern 3A formed on the wafer 2, an alignment deviation 12 between the pattern 3A and an ideal pattern 4 is measured. Hereinafter, an example of methods for measuring the alignment deviation will be specifically described.

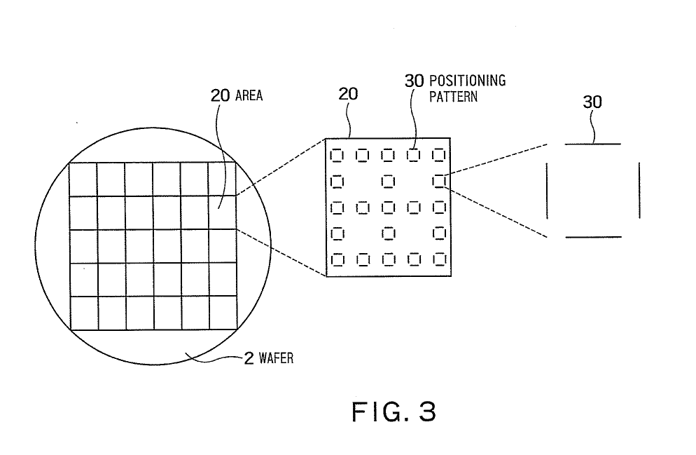

FIGS. 3 to 7 are views for explaining steps of measuring the alignment deviation between the patterns.

As shown in FIG. 3, a large number of positioning patterns 30 that determine relative positions to the imprinted patterns on the wafer 2 are previously formed in an area 20 of the wafer 2 which is subjected to imprinting.

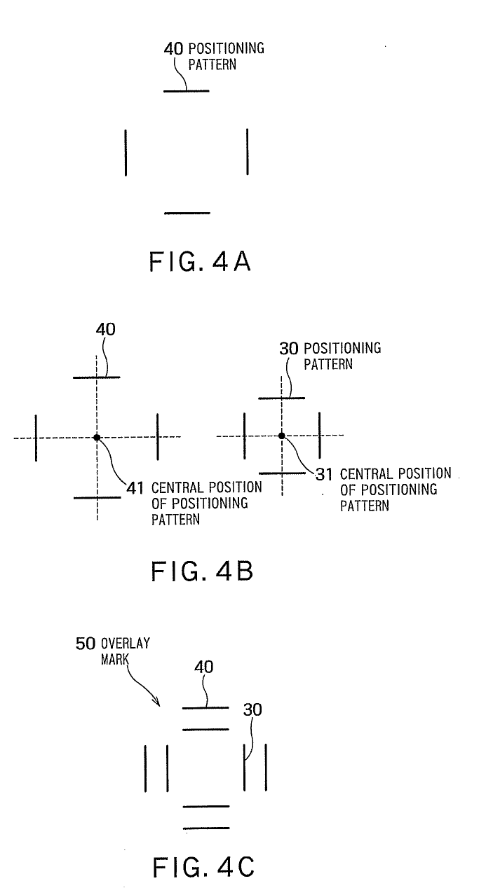

Further, as shown in FIG. 4A, oppositely to the positioning pattern 30, positioning patterns 40 that determine relative positions to the imprinted patterns on the wafer 2 are also previously formed on the master template 1. A central position 41 of the positioning pattern 40 and a central position 31 of the positioning pattern 30 are made to be located at the same position (FIG. 4B). Although the positioning pattern 40 is arranged so as to be outside the positioning pattern 30 in the figure, the positioning pattern 40 may be arranged so as to be inside the positioning pattern 30.

FIG. 4C shows a result of performing imprinting on the wafer 2 processed with the positioning patterns 40 by use of the master template 1 processed with the positioning patterns 30. The positioning pattern 30 and the positioning pattern 40 constitute an overlay mark 50.

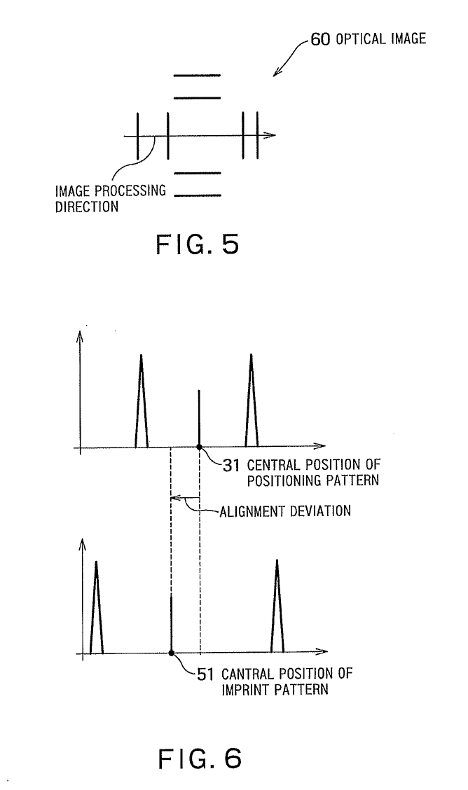

The overlay mark 50 is used for measuring an alignment deviation between the wafer 2 and the imprinted pattern. The overlay mark 50 is obtained by means of an optical image 60, which is then subjected to image processing in a direction of an arrow in FIG. 5, and the central position 31 of the positioning pattern 30 formed on the wafer 2 and a central position 51 of the imprinted pattern are obtained, to measure the alignment deviation (FIG. 6). Similarly, the alignment deviation is also measured in a direction vertical to the direction of the arrow in FIG. 5.

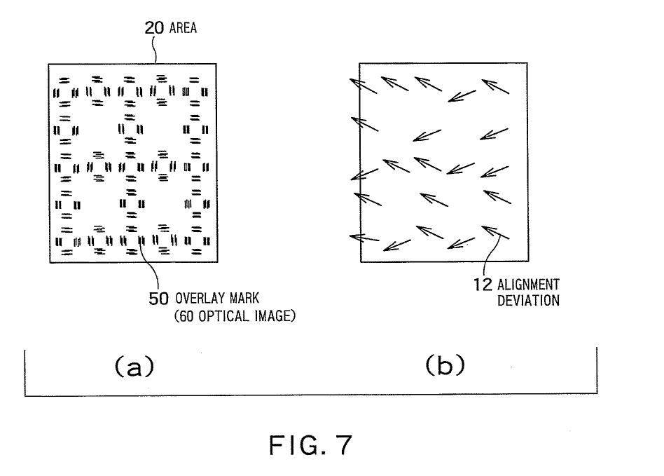

From the overlay marks 50 (optical images 60) in a large number of positions within the area which is subjected to imprinting, the alignment deviations 12 in a large number of positions within the area which is subjected to imprinting are measured (FIG. 7).

### [(3) Step of Performing Alignment-Deviation Correction, to Produce Template for Actual Imprinting]

Next, based on the measured alignment deviations 12, a correction value which minimizes the alignment deviations is obtained, to perform alignment-deviation correction, and a subtemplate 5 as the template for actual imprinting is produced from the master template 1.

Specifically, since the alignment deviations 12 in a large number of positions within the area which is subjected to imprinting are alignment deviations that occur at the time of performing imprinting, the pattern position of the template is corrected assuming the occurrence of deviations by the above alignment deviation amount, thereby to produce the subtemplate 5 (template for actual imprinting) by nanoimprinting from the master template 1. The subtemplate 5 is, for example, made of quartz.

Herein, at the time of performing nanoimprinting, it is preferable to apply the foregoing distortion correction 11 to the master template 1.

### [(4) Step of Performing Imprinting by Use of Template for Actual Imprinting, to Form Pattern on Wafer]

Next, the subtemplate 5 is imprinted to the wafer 2, to obtain a pattern 3B which is equivalent or extremely close to the ideal pattern 4.

The other steps can be performed in a similar manner to in the known nanoimprint method.

### Second Embodiment

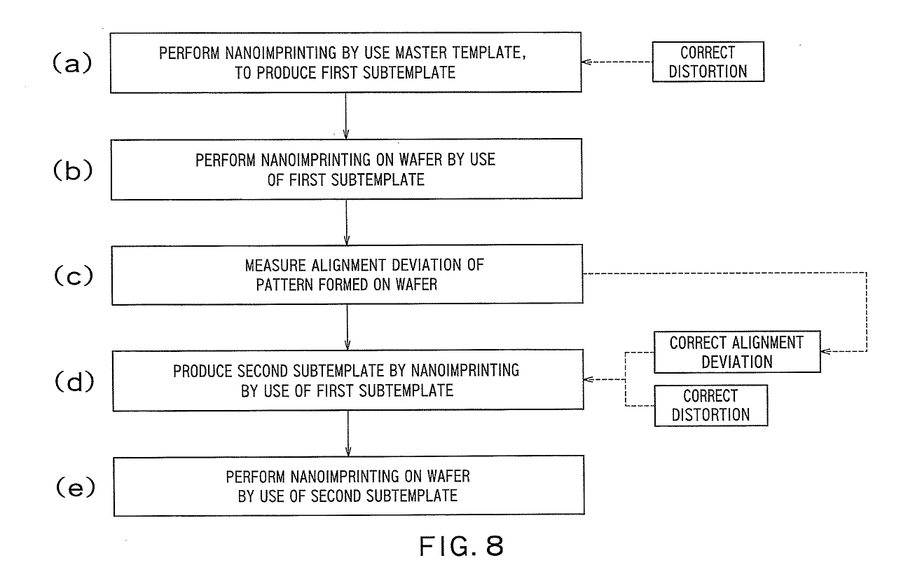

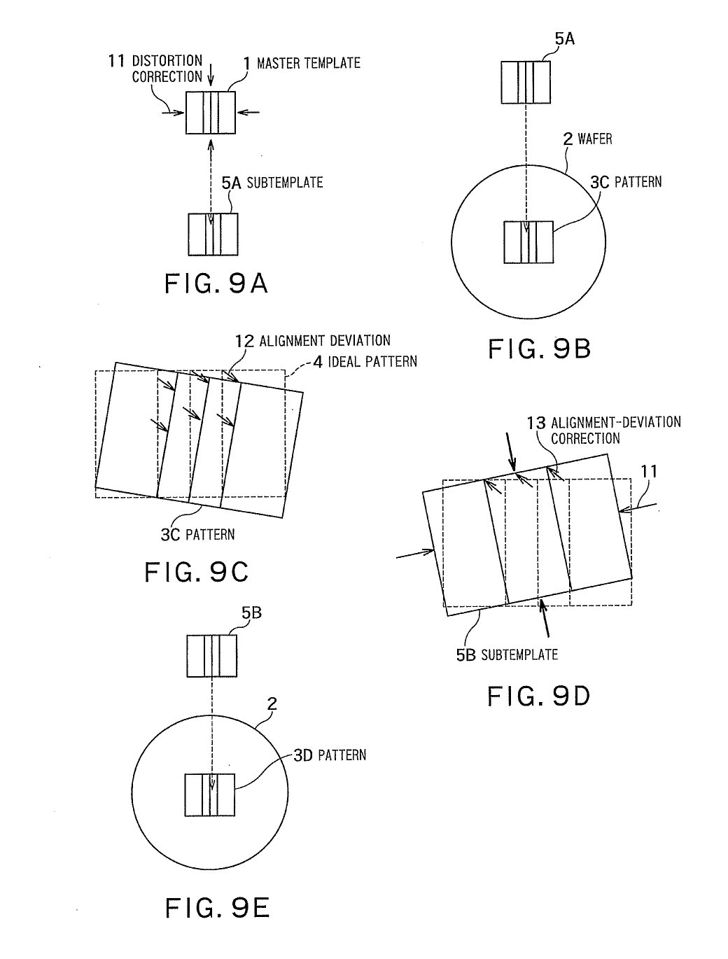

FIG. 8 is a flow diagram showing steps of a nanoimprint method according to a second embodiment. Further, FIGS. 9A to 9E are views for explaining the steps of the nanoimprint method according to the second embodiment.

The present embodiment is a nanoimprint method having the following steps:

(1) a step of producing a second template from a first template, and performing imprinting by use of the second template, to form a pattern on a wafer (FIGS. 8(a), (b) and FIGS. 9A, 9B);

(2) a step of measuring an alignment deviation of the pattern (FIGS. 8(c) and 9C);

(3) a step of performing alignment-deviation correction based on the measured alignment deviation, to produce a template for actual imprinting from the first template or the second template (FIGS. 8(d) and 9D); and

(4) a step of performing imprinting by use of the template for actual imprinting, to form a pattern on the wafer (FIG. 8(e) and FIG. 9E).

Hereinafter, the steps (1) to (4) will be sequentially described.

### [(1) Step of Forming Pattern on Wafer]

A subtemplate 5A (second template) is produced by nanoimprinting from a master template 1 (first template), and the subtemplate 5A is nanoimprinted to a wafer 2, to form a pattern 3C on the wafer 2. The master template 1 is, for example, one obtained by forming a concave-convex pattern on a fully transparent quartz substrate by plasma etching, and the subtemplate 5A is, for example, made of quartz.

Herein, at the time of performing nanoimprinting, the distortion correction 11 is preferably applied to the master template 1. Alternatively, the distortion correction 11 is preferably applied to the subtemplate 5A.

### [(2) Step of Measuring Alignment Deviation of Pattern]

Next, as for the pattern 3C formed on the wafer 2, an alignment deviation 12 between the pattern 3C and an ideal pattern 4 is measured. Although a specific measurement method is as described in the first embodiment, there is a difference in using the subtemplate 5A instead of the master template 1.

### [(3) Step of Performing Alignment-Deviation Correction, to Produce Template for Actual Imprinting]

Next, based on the measured alignment deviations 12, a correction value which minimizes the alignment deviations is obtained, to perform alignment-deviation correction, and a subtemplate 5B as the template for actual imprinting is produced from the subtemplate 5A. The master template 1 may be used in place of the subtemplate 5A.

Specifically, since the alignment deviations 12 in a large number of positions within the area which is subjected to imprinting are alignment deviations that occur at the time of performing imprinting, the pattern position of the template is corrected assuming the occurrence of deviations by the above alignment deviation amount, thereby to produce the subtemplate 5B (template for actual imprinting) by nanoimprinting from the subtemplate 5A or the master template 1. The subtemplate 5B is, for example, made of quartz.

Herein, at the time of performing nanoimprinting, it is preferable to apply the foregoing distortion correction 11 to the subtemplate 5A or the master template 1.

### [(4) Step of Performing Imprinting by Use of Template for Actual Imprinting, to Form Pattern on Wafer]

Next, the subtemplate 5B is imprinted to the wafer 2, to obtain a pattern 3D which is equivalent or extremely close to the ideal pattern 4.

The other steps can be performed in a similar manner to in the known nanoimprint method.

According to the embodiments, it is possible to produce an imprint method capable of highly accurately correcting an alignment deviation at the time of imprinting. It is thereby possible to reduce the alignment deviation at the time of imprinting. It is to be noted that the first embodiment has a smaller number of steps than the second embodiment, thereby being more advantageous in terms of cost.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A nanoimprint method, comprising:
performing imprinting by use of a first template, to form a pattern on a first substrate to be transferred;
measuring an alignment deviation of the pattern with respect to the first substrate to be transferred;
performing alignment-deviation correction based on the measured alignment deviation, to produce a third template by use of the first the template; and
performing imprinting by use of the third template, to form a pattern on a second substrate to be transferred.

2. The nanoimprint method according to claim 1, wherein the alignment deviation is measured through use of an overlay mark made up of a first positioning pattern processed on the first template and a second positioning pattern processed on the first substrate to be transferred.

3. The nanoimprint method according to claim 1, wherein at the time of performing imprinting by use of the first template, distortion correction is performed based on a result of measurement performed through use of a first alignment mark previously formed on the first template and a second alignment mark previously formed on the first substrate to be transferred.

4. The nanoimprint method according to claim 1, wherein, while the alignment-deviation correction is performed, distortion correction is also performed based on a result of measurement performed through use of the first alignment mark previously formed on the first template.

5. The nanoimprint method according to claim 1, wherein the first template and the third template are made of quartz.

6. A nanoimprint method, comprising:
producing a second template from a first template;
performing imprinting by use of a second template, to form a pattern on a first substrate to be transferred;
measuring an alignment deviation of the pattern with respect to the first substrate to be transferred;
performing alignment-deviation correction based on the measured alignment deviation, to produce a third template by use of the second template; and
performing imprinting by use of the third template, to form a pattern on a second substrate to be transferred.

7. The nanoimprint method according to claim 6, wherein the alignment deviation is measured through use of an overlay mark made up of a third positioning pattern processed on the second template and a second positioning pattern processed on the first substrate to be transferred.

8. The nanoimprint method according to claim 6, wherein at the time of producing the second template from the first template, distortion correction is performed based on a result of measurement performed through use of a first alignment mark previously formed on the first template.

9. The nanoimprint method according to claim 6, wherein at the time of performing imprinting by use of the second template, distortion correction is performed based on a result of measurement performed through use of a third alignment mark previously formed on the second substrate to be transferred.

10. The nanoimprint method according to claim 6, wherein, while the alignment-deviation correction is performed, distortion correction is also performed based on a result of measurement performed through use of the third alignment mark previously formed on the second template.

11. The nanoimprint method according to claim 6, wherein the first template, the second template and the third template are made of quartz.

12. A nanoimprint method, comprising:
producing a second template from a first template;
performing imprinting by use of the second template, to form a pattern on a first substrate to be transferred;
measuring an alignment deviation of the pattern with respect to the first substrate to be transferred;
performing alignment-deviation correction based on the measured alignment deviation, to produce a third template by use of the first template; and
performing imprinting by use of the third template, to form a pattern on a second substrate to be transferred.

13. The nanoimprint method according to claim 12, wherein the alignment deviation is measured through use of an overlay mark made up of a third positioning pattern processed on the second template and a second positioning pattern processed on the first substrate to be transferred.

14. The nanoimprint method according to claim 12, wherein at the time of producing the second template from the first template, distortion correction is performed based on a result of measurement performed through use of a first alignment mark previously formed on the first template.

15. The nanoimprint method according to claim 12, wherein at the time of performing imprinting by use of the second template, distortion correction is performed based on a result of measurement performed through use of a third alignment mark previously formed on the second substrate to be transferred.

16. The nanoimprint method according to claim 12, wherein, while the alignment-deviation correction is performed, distortion correction is also performed based on a result of measurement performed through use of the first alignment mark previously formed on the second template.

17. The nanoimprint method according to claim 12, wherein the first template, the second template and the third template are made of quartz.
